(19) United States
(12) Patent Application Publication
(10) Pub. No.: US 2021/0073112 A1
(43) Pub. Date: Mar. 11, 2021

(54) SYSTEM AND METHOD FOR GENERATING CONFIGURATION FILES AND PERFORMING TEST USING THE CONFIGURATION FILES

(71) Applicants: Inventec (Pudong) Technology Corporation, Shanghai (CN); INVENTEC CORPORATION, Taipei (TW)

(72) Inventor: Yong-Jun SHI, Shanghai (CN)

(73) Assignees: Inventec (Pudong) Technology Corporation, Shanghai (CN); INVENTEC CORPORATION, Taipei (TW)

(21) Appl. No.: 17/013,861

(22) Filed: Sep. 8, 2020

(30) Foreign Application Priority Data
Sep. 9, 2019 (CN) 2019108647421

(51) Int. Cl. G06F 11/36; G06F 8/71; G06F 21/60

(52) U.S. Cl. CPC G06F 11/3688; G06F 21/602; G06F 8/71

(57) ABSTRACT

A system and method for generating configuration files and performing test by using the configuration files are disclosed. The configuration generation system configures the identification code corresponding to each testing mode as a comparison table, and configures at least one set of identification codes corresponding to each testing collection and the execution configuration of the identification code to generate the configuration files, and the production line testing system parses the test script to obtain the testing mode and the execution configuration of the testing mode according to the identification comparison table and the configuration files, so as to execute the test. The test program is convenient by providing the configuration files.

### CROSS REFERENCES TO RELATED APPLICATIONS

This application claims the benefit of priority to Chinese Patent Application No. CN201910864742.1, entitled “System and Method for Generating Configuration Files and Performing Test Using the Configuration Files”, filed with CNIPO on Sep. 9, 2019, the contents of which are incorporated herein by reference in its entirety.

### TECHNICAL FIELD

The present application relates to a system and method for generating and executing test, in particular, to a system and method for generating configuration files and performing test using the configuration files.

### BACKGROUND

For testing of different clients with different requirements, the traditional method customizes the functions for different requirements, so as to provide different binary executable test program for customers. However, the traditional method has the following technical problems: there are so many customers, and each customer has different products for testing, therefore it has to provide and maintain different binary executable test programs, so that customers can use them for their own tests. This results in the significant increase in maintenance costs and error-prone. In addition, it is difficult to update the function of the test program. That is, if a change of the test or a new test is required, a new version of the executable test program must be updated.

It has been a long-existing problem that the maintenance of the executable test program is inconvenient, and therefore it is necessary to propose an improved technical solution to solve the problem.

### SUMMARY

The present disclosure provides a system and method for generating configuration files and performing test using the configuration file, to solve the inconvenient caused by providing different executable test programs.

The system for generating configuration files and performing test using configuration files includes: a configuration generation system and a production line testing system. The configuration generation system further includes: a setting module, a collection setting module, a configuration generation module, an encryption module and a configuration transmission module. The production line testing system further includes: a receiving module, a decryption module, a parsing module, and a testing module.

The setting module of the configuration generation system sets an identification code corresponding to each testing mode as a recognition comparison table; the collection setting module of the configuration generation system sets at least one set of identification codes corresponding to each testing collection and execution configuration of the identification code; the configuration generation module of the configuration generation system generates the testing collection as configuration file; the encryption module of the configuration generation system encrypts the configuration file; and the configuration transmission module of configuration generation system transmits the identification comparison table and the encrypted configuration files.

The receiving module of the production line testing system receives the identification comparison table and the encrypted configuration files from the configuration transmission module; the decryption module of the production line testing system decrypts the configuration file; and the parsing module of the production line testing system reads the test script, and parsing the test scripts according to the identification comparison table and the decrypted configuration files to obtain the testing mode and the execution configuration of the testing mode; and the testing module of the production line testing system executes the test according to the testing mode and the execution configuration of the testing mode.

The present disclosure further discloses a method for generating configuration files and performing test using configuration files. The method includes the following steps:

Firstly, the configuration generation system sets an identification code corresponding to each testing mode as a recognition comparison table; then, the configuration generation system sets at least one set of identification codes corresponding to each testing collection and execution configuration of the identification code; and then, the configuration generation system generates the testing collection as configuration file; then, the configuration generation system encrypts the configuration file; then, the configuration generation system transmits the identification comparison table and the encrypted configuration files to the production line testing system; and then, the production line testing system decrypts on the configuration file; then, the production line testing system reads the test script, and parses the test script according to the identification comparison table and the decrypted configuration files to obtain the testing mode and the execution configuration of the testing mode; finally, the production line testing system executes the test according to the testing mode and the execution configuration of the testing mode.

The system and method of the present disclosure set the identification code corresponding to each testing mode through the configuration generation system as a recognition comparison table, and set at least one set of identification code corresponding to each testing collection and execution configuration of the identification codes, and generates a configuration file, the production line testing system parses the test script according to the identification comparison table and the configuration files to obtain the testing mode and execution configuration of the testing mode.

The present disclosure can improve the convenient in maintenance of the testing program by providing configuration files.

### BRIEF DESCRIPTION OF THE DRAWINGS

FIG. 1 is a schematic diagram of a system for generating configuration files and performing test by using configuration files according to the present disclosure.

FIG. 2 is a schematic diagram of the identification comparison table for generating test configuration files and performing test by using configuration files according to the present disclosure.

FIG. 3 is a schematic diagram of the generation of test configuration files and the test by using configuration files according to the present disclosure.

FIG. 4 is a flow chart of a method for generating configuration files and performing test by using configuration files according to the present disclosure.

### COMPONENT REFERENCE NUMERALS

10 Configuration generation system
11 Setting module
12 Collection setting module
13 Configuration generation module
14 Encryption module
15 Configuration transmission module
20 Production line testing system
21 Receiving module
22 Decryption module
23 Parsing module
24 Testing module
31 Identification comparison table
32 Testing collection
   Step 101: The configuration generation system sets the identification code corresponding to each testing mode as an identification comparison table.
   Step 102: The configuration generation system sets at least one set of identification codes corresponding to each testing configuration and execution configuration of the identification codes.
   Step 103: Configuration generation system generates a test collection as a configuration files.
   Step 104: Configuration generation system encrypts the configuration files.
   Step 105: Configuration generation system transmits the identification comparison table and the encrypted configuration files to the production line testing system.
   Step 106: The production line testing system decrypts the configuration files.
   Step 107: The production line testing system reads the test script, and parses the test script according to the identification comparison table and the decrypted configuration files to obtain the testing mode and the execution configuration of the testing mode.
   Step 108: The production line testing system executes the test according to the testing mode and the execution configuration of the testing mode.

### DETAILED DESCRIPTION OF THE PREFERRED EMBODIMENTS

The embodiments of the present disclosure are described in detail below with reference to the accompanying drawings and embodiments, in which the present disclosure can be fully understood and implemented by the technical means of solving the technical problems and achieving the technical effects.

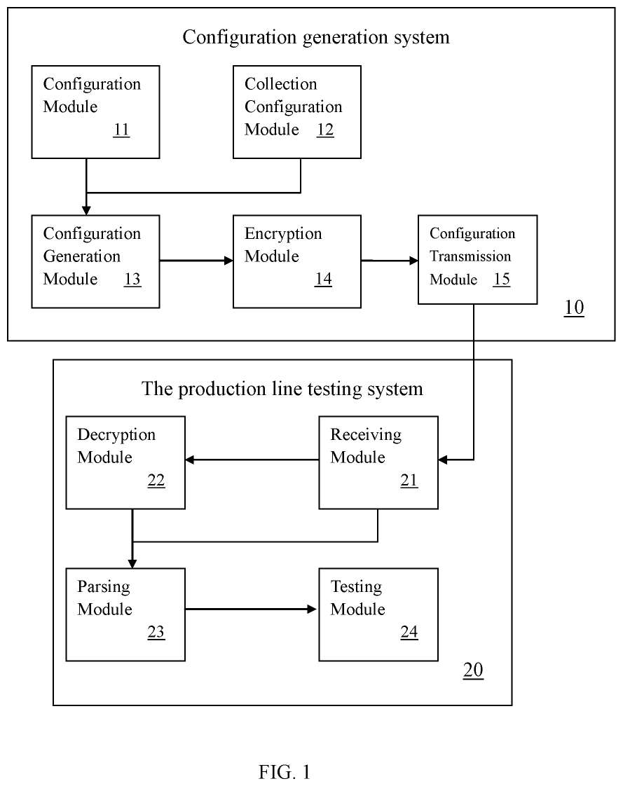

The following is a description of the system for generating configuration files and performing test by using the configuration files. The following descriptions all refers to FIG. 1. FIG. 1 is a schematic diagram of a system for generating test configuration files and performing tests by using the configuration files according to the present disclosure.

The system for generating configuration files and performing test by using configuration files includes: a configuration generation system 10 and a production line testing system 20. The configuration generation system 10 further includes: a setting module 11, a collection setting module 12, a configuration generation module 13, an encryption module 14, and a configuration transmission module 15. The production line testing system 20 further includes a receiving module 21, a decryption module 22, a parsing module 23, and a testing module 24.

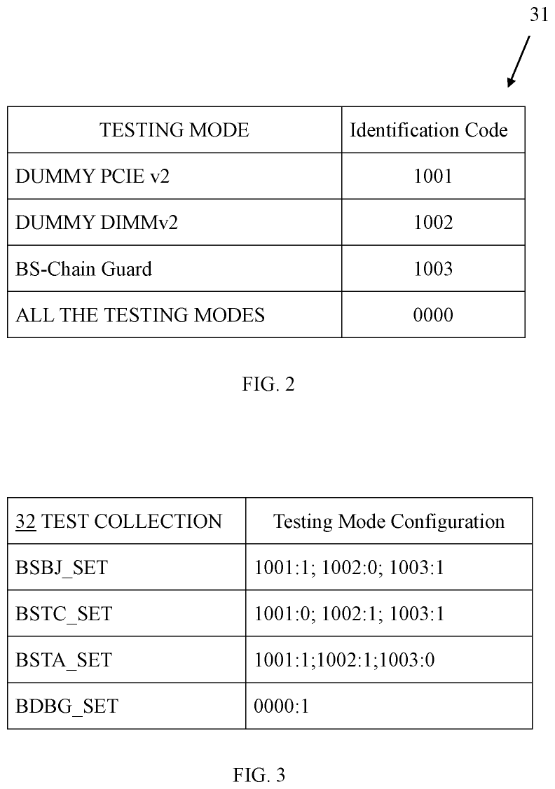

Please referring to FIG. 2, FIG. 2 is a schematic diagram of the identification comparison table of the system for generating configuration files and performing test by using the configuration files in the present disclosure.

The configuration generation system 10 provides a user interface to input an identification code corresponding to each testing mode, the setting module 11 of the configuration generation system 10 generates an identification comparison table 31 according to the identification code corresponding to each testing mode.

Specifically, the setting module 11 of the configuration generation system 10 can configure the “DUMMY PCIE v2 testing mode” with configuration identifier “1001”; the setting module 11 of the configuration generation system 10 can configure the “DUMMY DIMM v2 testing mode” with the configuration identification code “1002”; the setting module 11 of the configuration generating system 10 can configure the “BS-Chain Guard testing mode” with the configuration identification code “1003”; the setting module 11 of the configuration generating system 10 can configure the “all the testing modes” with the configuration identification code “0000”, and the setting module 11 of the configuration generation system 10 can generate the identification comparison table 31 according to the above configurations. The exemplary embodiment is merely an example, and does not limit the scope of the present disclosure.

Please referring to FIG. 3, FIG. 3 is a schematic diagram of testing collection of the system for generating configuration files and performing test by using the configuration files in the present disclosure.

The configuration generation system 10 provides a user interface to input at least one set of identification codes corresponding to each testing collection 32 and the execution configurations of the identification code, the collection setting module 12 of the configuration generation system 10 can configure at least one set of identification codes corresponding to each testing collection 32 and execution configuration of the identification code.

Specifically, the collection setting module 12 of the configuration generation system 10 configures the testing collection 32 “BSBJ_SET” with the identification code “1001” and configures the execution configuration of the corresponding identification code with “1”; the collection setting module 12 of the configuration generation system 10 configures the testing collection 32 “BSBJ_SET” with the identification code “1002” and configures the execution configuration of the corresponding identification code with “0”; the collection setting module 12 of the configuration generation system 10 configures the testing collection 32 “BSBJ_SET” with the identification code “1003” and configures the execution configuration of the corresponding identification code with “1”. The exemplary embodiment is merely an example, and does not limit the scope of the present disclosure.

The identification code of the testing collection 32 “BSBJ_SET being “1001” and the execution configuration of the corresponding identification code being “1” indicate that “DUMMY PCIE v2 testing mode” corresponding to the identification code “1001” is “enabled”. That is, the “DUMMY PCIE v2 testing mode” should perform the test. The identification code of the testing collection 32 “BSBJ_SET” being “1002” and the execution configuration of the corresponding identification code being “0” indicate that “DUMMY DIMM v2 testing mode” corresponding to the identification code “1002” is “disabled”. That is, the “DUMMY DIMM v2 testing mode” should not perform the test. The exemplary embodiment is merely an example, and does not limit the scope of the present disclosure.

Specifically, the collection setting module 12 of the configuration generation system 10 configures the testing collection 32 “BSTC_SET” with the identification code “1001” and configures the execution configuration of the corresponding identification code with “0”; the collection setting module 12 of the configuration generation system 10 configures the testing collection 32 “BSTC_SET” with the identification code “1002” and configures the execution configuration of the corresponding identification code with “1”; the collection setting module 12 of the configuration generation system 10 configures the testing collection 32 “BSTC_SET” with the identification code “1003” and configures the execution configuration of the corresponding identification code with “1”. The exemplary embodiment is merely an example, and does not limit the scope of the present disclosure.

Specifically, the collection setting module 12 of the configuration generation system 10 configures the testing collection 32 “BSTA_SET” with the identification code “1001” and configures the execution configuration of the corresponding identification code with “1”; the collection setting module 12 of the configuration generation system 10 configures the testing collection 32 “BSTA_SET” with the identification code “1002” and configures the execution configuration of the corresponding identification code with “1”; the collection setting module 12 of the configuration generation system 10 configures the testing collection 32 “BSTA_SET” with the identification code “1003” and configures the execution configuration of the corresponding identification code with “0”. The exemplary embodiment is merely an example, and does not limit the scope of the present disclosure.

Specifically, the collection setting module 12 of the configuration generation system 10 configures the testing collection 32 “BDBG_SET” with the identification code “0000” and configures the execution configuration of the corresponding identification code with “1”. The exemplary embodiment is merely an example, and does not limit the scope of the present disclosure.

After the collection setting module 12 of the configuration generation system 10 configures the at least one set of identification codes corresponding to each of the testing collection 32 and the execution configurations of the identification codes, the configuration generation module 13 of the configuration generation system 10 generates the testing collection 32 into the configuration files, and the configuration files are stored in format of cfg files.

After the configuration generation module 13 of the configuration generation system 10 generates the testing collection 32 into configuration files, the encryption module 14 of the configuration generation system 10 perform encryption on the configuration files. As for the encryption process of the configuration files, please refer to the existing technology, and will not be repeated herein. Then, the configuration transmission module 15 of the configuration generation system 10 transmits the identification comparison table 31 and the encrypted configuration files to the production line testing system 20, and the configuration generation system 10 and the production line testing system 20 are connected by the network. The exemplary embodiment is merely an example, and does not limit the scope of the present disclosure.

When the configuration transmission module 15 of the configuration generation system 10 transmitting the identification comparison table 31 and the encrypted configuration files to the production line testing system 20, the receiving module 21 of the production line testing system 20 receives the identification comparison table 31 and the encrypted configuration files from the configuration transmission module 15 of the configuration generation system 10.

Then, the decryption module 22 of the production line testing system 20 performs decryption on the encrypted configuration files. As for the decryption process of the configuration files, please refer to the existing technology, and will not be repeated herein. After the decryption module 22 of the production line testing system 20 decrypts the configuration files, the parsing module 23 of the production line testing system 20 reads the test script, and the parsing module 23 of the production line testing system 20 parses the test script to obtain the testing mode and the execution configurations of the testing mode, according to the identification comparison table 31 and the decrypted configuration files.

Specifically, assuming that the test script includes a testing collection “BSTA_SET”, the parsing module 23 of the production line testing system 20 reads the test script, and the parsing module 23 of the production line testing system 20 queries that the identification code is “1001” and the execution configuration of the corresponding identification code is “1”; the identification code is “1002” and the execution configuration of the corresponding identification code is “1”; the identification code is “1003” and the execution configuration of the corresponding identification code is “0”, from the decrypted configuration files according to the testing collection “BSTA_SET” in the test script.

That is, “DUMMY PCIE v2 testing mode” is “enabled”, in other words, “DUMMY PCIE v2 testing mode” should perform test. “DUMMY DIMM v2 testing mode” is “enabled”, in other words, “DUMMY DIMM v2 testing mode” should perform test. “BS-Chain Guard testing mode” is “disabled”, in other words, the “BS-Chain Guard testing mode” should not be tested. The exemplary embodiment is merely an example, and does not limit the scope of the present disclosure.

Specifically, assuming that the test script includes testing collection “BDBG_SET”, the parsing module 23 of the production line testing system 20 reads the test script, and the parsing module 23 of the production line testing system 20 queries the identification code is “0000” and the execution configuration of the corresponding identification code is “1” from the decrypted configuration files according to the testing collection “BDBG_SET” in the test script.

That is, “DUMMY PCIE v2 testing mode” is “enabled”, in other words, “DUMMY PCIE v2 testing mode” should perform test. “DUMMY DIMM v2 testing mode” is “enabled”, in other words, “DUMMY DIMM v2 testing mode” should perform test. “BS-Chain Guard testing mode” is “disabled”, in other words, the “BS-Chain Guard testing mode” should not perform test. The exemplary embodiment is merely an example, and does not limit the scope of the present disclosure.

After the parsing module 23 of the production line testing system 20 parses the execution configuration of the testing mode and the testing mode, the testing module 24 of the production line testing system 20 can execute the test according to the testing mode and the execution configuration of the testing mode.

According to the above examples, the parsing module 23 of the production line testing system 20 queries that the identification code is “1001” and the execution configuration of the corresponding identification code is “1”, the identification code is “1002” and the execution configuration of the corresponding identification code is “1”, the identification code is “1003” and the execution configuration of the corresponding identification code is “0”, from the decrypted configuration files according to the testing collection “BSTA_SET” in the test script.

The testing module 24 of the production line testing system 20 can perform the test of “DUMMY PCIE v2 testing mode”; the testing module 24 of the production line testing system 20 can perform the test of “DUMMY DIMM v2 testing mode”; the testing module 24 of production line testing system 20 does not perform the test of “BS-Chain Guard testing mode”. The exemplary embodiment is merely an example, and does not limit the scope of the present disclosure.

According to the above examples, the parsing module 23 of the production line testing system 20 queries that the identification code is “0000” and the execution configuration of the corresponding identification code is “1”, from the decrypted configuration files according to the testing collection “BDBG_SET” in the test script.

The testing module 24 of the production line testing system 20 performs the test of “DUMMY PCIE v2 testing mode”; the testing module 24 of the production line testing system 20 performs the test of “DUMMY DIMM v2 testing mode”; the testing module 24 of production line testing system 20 performs the test of “BS-Chain Guard testing mode”. The exemplary embodiment is merely an example, and does not limit the scope of the present disclosure.

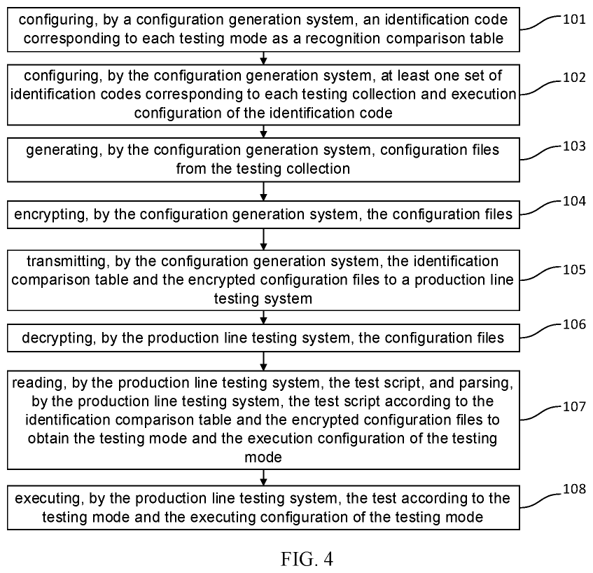

Please referring to FIG. 4, FIG. 4 is a flowchart of a method for generating a configuration files and performing test by using the configuration files according to the present disclosure.

Firstly, the configuration generation system configures an identification code corresponding to each testing mode as a recognition comparison table (step 101); then, the configuration generation system configures at least one set of identification codes corresponding to each testing collection and an execution configuration of the identification code (step 102); then, the configuration generation system generates the testing collection as a configuration files (step 103); then, the configuration generation system performs encryption on the configuration files (step 104); then, the configuration generation system transmits the identification comparison table and the encrypted configuration files to the production line testing system (step 105); then, the production line testing system performs decryption on the configuration files (step 106); then, the production line testing system reads the test script and parses the test script to obtain the testing mode and the execution configuration of the testing mode according to the identification comparison table and the decrypted configuration files (step 107); finally, the line test system performs the test in accordance with the testing mode and the execution configuration of the testing mode (step 108).

In summary, in the present disclosure, the configuration generation system configures the identification code corresponding to each testing mode as a comparison table, and configures at least one set of identification codes corresponding to each testing collection and the execution configuration of the identification code to generate the configuration files, and the production line testing system parses the test script to obtain the testing mode and the execution configuration of the testing mode according to the identification comparison table and the configuration files, so as to execute the test.

The present disclosure can solve the problem that it is inconvenient to maintain the executable test program. The test program is convenient by providing the configuration files.

Although the disclosed embodiments of the present disclosure are as described above, the contents are not intended to directly limit the scope of the disclosure. Any changes in the form and details of the embodiments without departing from the spirit and scope of the disclosure will fall in the scope of the present disclosure. The scope of the disclosure is determined by the scope of the appended claims.

1. A system for generating configuration files and performing test by using the configuration files, comprising:
a configuration generation system, wherein the configuration generation system comprises;
a setting module, configuring an identification code corresponding to each testing mode as a recognition comparison table;
a collection setting module, configuring at least one set of identification codes corresponding to each testing collection and an execution configuration of the identification code;
a configuration generating module, generating configuration files from the testing collection;
an encryption module, encrypting the configuration files; and
a configuration transmission module, transmitting the identification comparison table and the encrypted configuration files; and
a production line testing system, wherein the line test system comprises:
a receiving module, receiving the identification comparison table and the encrypted configuration files from the configuration transmitting module;
a decryption module, decrypting the configuration files;
a parsing module, reading the test script, and parsing the test script according to the identification comparison table and the decrypted configuration files to obtain the testing mode and the execution configuration of the testing mode; and
a testing module, executing the test according to the testing mode and the execution configuration of the testing mode.

2. The system for generating configuration files and performing tests by using the configuration files according to claim 1, wherein the executing configuration is “enabled” or “disabled”, “1” indicates “enabled”, and “0” indicates “disabled”.

3. The system for generating configuration files and performing tests by using the configuration files according to claim 1, wherein the configuration files are stored in the format of cfg files.

4. The system for generating configuration files and performing tests by using the configuration files according to claim 1, wherein the testing module executes the test of the testing mode when the executing configuration of the testing mode is “enabled”.

5. The system for generating configuration files and performing tests by using configuration files according to claim 1, wherein the testing module does not execute the test of testing mode when the executing configuration of the testing mode is “disabled”.

6. A method for generating configuration files and performing tests by using the configuration files, comprising:
configuring, by a configuration generation system, an identification code corresponding to each testing mode as a recognition comparison table;
configuring, by the configuration generation system, at least one set of identification codes corresponding to each testing collection and execution configuration of the identification code;
generating, by the configuration generation system, configuration files from the testing collection;
encrypting, by the configuration generation system, the configuration files;
transmitting, by the configuration generation system, the identification comparison table and the encrypted configuration files to a production line testing system;
decrypting, by the production line testing system, the configuration files;
reading, by the production line testing system, the test script, and parsing, by the production line testing system, the test script according to the identification comparison table and the encrypted configuration files to obtain the testing mode and the execution configuration of the testing mode; and
executing, by the production line testing system, the test according to the testing mode and the executing configuration of the testing mode.

7. The method for generating configuration files and performing tests by using the configuration files according to claim 6, wherein the executing configuration is “enabled” or “disabled”, “1” indicates “enabled”, and “0” indicates “disabled”.

8. The method for generating configuration files and performing tests by using the configuration files according to claim 6, wherein the configuration files are stored in the format of cfg files.

9. The method for generating configuration files and performing tests by using the configuration files according to claim 6, in the executing of, by the production line testing system, the test according to the testing mode and the executing configuration of the testing mode, when the execution configuration of the testing mode is “enabled”, the production line test system executes the test of the testing mode.

10. The method for generating configuration files and performing tests by using configuration files according to claim 6, in the executing of, by the production line testing system, the test according to the testing mode and the executing configuration of the testing mode, when the execution configuration of the testing mode is “disabled”, the production line test system does not execute the test of the testing mode.
